(19) United States
(12) Patent Application Publication
(10) Pub. No.: US 2016/0283978 A1
(43) Pub. Date: Sep. 29, 2016

(54) SWIPE-ABLE ADVERTISEMENTS

(71) Applicant: TangoMe, Inc., Mountain View, CA (US)

(72) Inventors: Richard RABBAT, Palo Alto, CA (US); Eva CHAU, Mountain View, CA (US); Xu LIU, San Jose, CA (US); Adam KIRKWOOD, Milpitas, CA (US)

(21) Appl. No.: 15/080,419

(22) Filed: Mar. 24, 2016

Related U.S. Application Data
(60) Provisional application No. 62/137,708, filed on Mar. 24, 2015.

(51) Int. Cl. G06Q 30/02; G06F 3/0482; G06F 3/0484; G06F 3/0488

(52) U.S. Cl. CPC G06Q 30/0257; G06Q 30/0267; G06F 3/04883; G06F 3/0482; G06F 3/04842

(57) ABSTRACT

In a computer-implemented method for determining a user's interest in an advertisement, a messaging application is executed at a computing device, the messaging application for facilitating communication between a user interacting with the messaging application and other users interacting with other instances of the messaging application. An advertisement is presented at a touch-screen display of the computing device, the advertisement native to the messaging application. A swiping interaction with the advertisement is received at the touch-screen display of the computing device, wherein a direction of the swiping interaction with the advertisement is indicative of a user's interest in the advertisement. Data associated with the user's interest in the advertisement is stored.

### REFERENCE TO RELATED APPLICATIONS

This application claims priority to and the benefit of co-pending U.S. Patent Provisional Patent Application 62/137,708, filed on Mar. 24, 2015, entitled “Swipe-able advertisements,” by Rabbat et al., having Attorney Docket No. TNGO-041.PRO, and assigned to the assignee of the present application, which is hereby incorporated by reference in its entirety.

### BACKGROUND

Conventional technologies and methods for providing advertisements in web-based applications frequently distract the user and impact the user's experience in a negative way.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 illustrates an example user profile of a messaging application, in accordance with an embodiment.

FIG. 2 illustrates another example user profile of a messaging application, in accordance with an embodiment.

FIG. 3 illustrates an example advertisement displayed within a messaging application, in accordance with an embodiment.

FIG. 4 illustrates another example advertisement displayed within a messaging application, in accordance with an embodiment.

FIG. 5 illustrates an example sequence of an advertisement displayed as an interstitial between user profiles, in accordance with an embodiment.

FIG. 6 is a block diagram that illustrates an embodiment of an advertisement presenter, in accordance with an embodiment.

FIGS. 7A through 7C depict a flow diagram for a method for determining a user's interest in an advertisement, in accordance with an embodiment.

FIG. 8 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While various embodiments are discussed herein, it will be understood that they are not intended to be limit these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

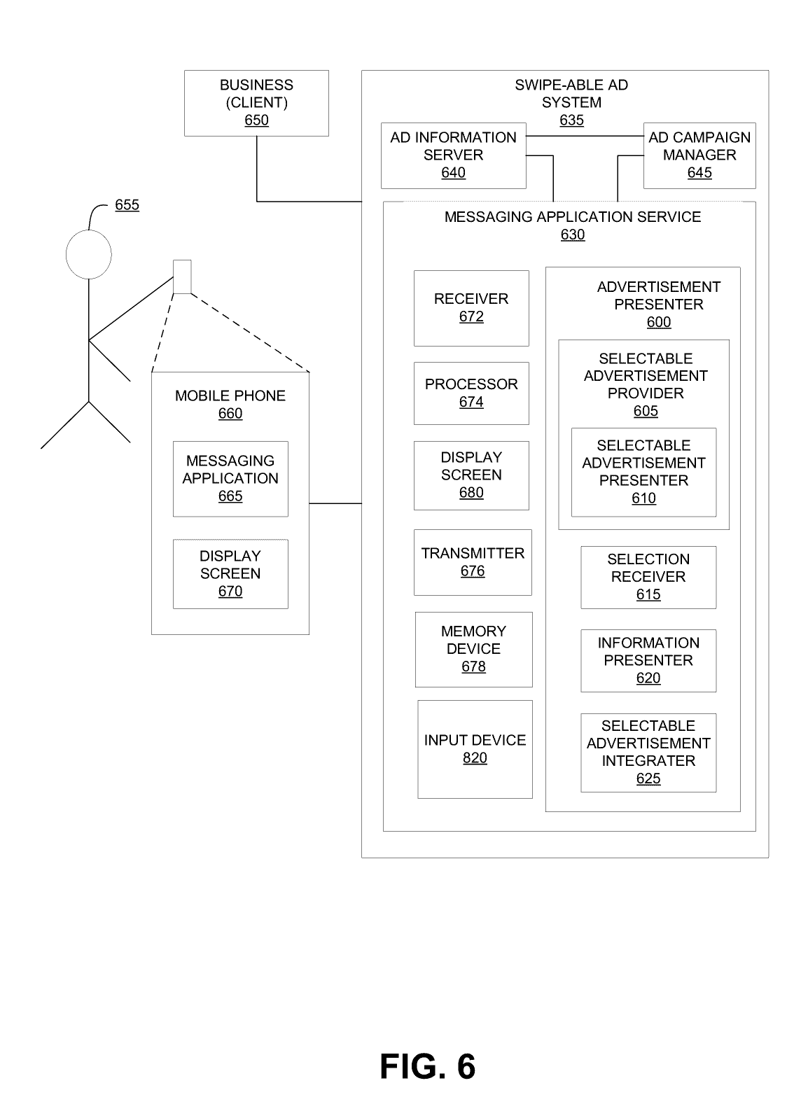

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “executing,” “presenting,” “receiving,” “storing,” “determining,” “redirecting,” or the like, refer to the actions and processes of an electronic device such as: a processor (e.g., data processor), a memory, a mobile electronic device, electronic computing device (or portion thereof), module or system, such as, but not limited to, an advertisement presenter 600 (See FIG. 6), or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable (e.g., computer-readable) instructions residing on some form of non-transitory computer-readable storage medium or computer-program product, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration

### Overview of Embodiments and Discussion

Conventional technologies and methods for providing advertisements (“ads”) in web-based applications frequently distract the user and impact the user's experience in a negative way. For instance, the presentation of an advertisement may disrupt the user's interaction with an application by requiring a different type of interaction with the advertisement than the application requires. In other words, advertisements presented within applications may disrupt the user's experience. As an example, an advertisement may pop-up or otherwise interfere with a user's interaction with a particular application. To remove the advertisement, the user may have to interact with the advertisement (e.g., select an “X” button at a corner of the advertisement. This interaction may be different than the interaction required by the application being used.

Moreover, tracking user interactions with advertisements is a useful component of understanding the effectiveness of advertisements, as well as providing a means for monetization of the advertisements. When tracking interactions, and attempting to determine a user's impression of an advertisement based on the interactions, the method of presentation of the advertisement may disrupt or obfuscate the impression. For example, if the advertisement disrupts the user's experience, the user's impression of the advertisement may be indicative of their displeasure or annoyance with the means of presentation, rather than with the advertisement itself.

Embodiments described herein provide for tracking a user's interest in an advertisement using the same experience as the application the user is using. For example, the experience of swiping pictures to the left or right enables users to explore new content and enables a system to understand the users' interests. Embodiments described herein monetize advertisements which use the same experience as the application being used so that the user's behavior may be tracked while users can enjoy the swiping experience. Embodiments enable advertisers are able to receive immediate feedback on the users' reactions to the advertisements.

In one embodiment, a computer-implemented method for determining a user's interest in an advertisement is provided. A messaging application is executed at a computing device, the messaging application for facilitating communication between a user interacting with the messaging application and other users interacting with other instances of the messaging application. An advertisement is presented at a touch-screen display of the computing device, the advertisement native to the messaging application. A swiping interaction with the advertisement is received at the touch-screen display of the computing device, wherein a direction of the swiping interaction with the advertisement is indicative of a user's interest in the advertisement. Data associated with the user's interest in the advertisement is stored.

In one embodiment, responsive to the direction of swiping interaction with the advertisement being to the left, it is determined that the user is not interested in the advertisement. In one embodiment, responsive to the direction of swiping interaction with the advertisement being to the right, it is determined that the user is interested in the advertisement. In one embodiment, responsive to determining that the user is interested in the advertisement, the messaging application is redirected to a landing page associated with the advertisement.

In one embodiment, the advertisement comprises a call to action (CTA) button. In one embodiment, responsive to receiving a user interaction with the CTA button, the messaging application is redirected to a landing page associated with the advertisement.

In one embodiment, a plurality of user profiles is presented within the messaging application at the touch-screen display of the computing device, wherein each user profile is individually presented. A swiping interaction with each user profile is received at the touch-screen display of the computing device, wherein a direction of the swiping interaction with each user profile is indicative of a user's interest in each user profile. In one embodiment, the advertisement is presented as an interstitial between two user profiles of the plurality of user profiles.

Embodiments of the present technology provide a monetization solution for messaging applications that delivers revenue and does not impact the user's experience. More specifically, embodiments enable advertisements to be used in a messaging application to mimic the interactions of the messaging application to isolate the impact of the advertisement, to identify a user's interest in the advertisement based on the received interaction, and to direct the user to information related to the advertisement based on an indication of a positive impression of the advertisement.

In accordance with embodiments, the advertisements will be displayed as part of an application's native platform. Advertisements, according to embodiments, are displayed within a messaging application (e.g., Tango™). For instance, the advertisement may be displayed as a native advertisement within the messaging application. For example, the advertisement may be displayed as an interstitial between user profiles within a user profile review portion of the messaging application.

Embodiments provide methods and systems that enable advertisements to be displayed as part of a messaging application while providing the same user experience of the messaging application. Embodiments described herein enable business users to upload native advertisements that allow the users interactivity capabilities. Users can swipe the advertisement to the left or right to indicate the users' interest in the advertisements. For example, the user swiping the advertisement unit to the left indicates to the messaging application or other entity (computer, organization, etc.) that the user is not interested in the ad. The user swiping the advertisement to the right indicates to the messaging application or other entity that the user is interested in the advertisement.

In one embodiment, the user indicating interest in the advertisement also causes the messaging application to be redirected to a landing page associated with the advertisement. In one embodiment, there is a call-to-action (CTA) button in the advertisement, where user interaction with the call-to-action button causes the messaging application to be redirected to a landing page associated with the advertisement.

In one embodiment, the messaging application stores all swipe actions and call-to-action button interaction actions to a store that stores the actions signifying the user's behavior, such that the actions may be observed. In one embodiment, the messaging application shares the swipe action feedback with advertisers.

For example, in one embodiment, a user is navigating through a user profile review portion of the messaging application. The user profile review portion presents user profiles of other user in a single screen format. The user may interact with an individual user profile to indicate their interest in the user profile. In one embodiment, a swiping interaction is received to indicate interest in a user profile. For example, a swiping interaction to the right is used to convey interest in the user profile, and a swiping interaction to the left is used to convey a lack of interest in the user profile. Once a swiping interaction is received for a user profile is received, the user profile review portion presents another user profile. Sometimes, rather than presenting another user profile, the messaging application presents an advertisement as an interstitial between user profiles. In one embodiment, the user can interact with the advertisement in the same fashion as with the user profiles, where the same swiping direction is indicative or the same information regarding interest in the advertisement.

Accordingly, embodiments of the present invention provide a method and system for providing advertisements within a messaging application and for providing interaction with the advertisements using the same user experience as the messaging application. Moreover, embodiments of the present invention provide for tracking user interactions for determining a user's interest in the advertisement, and for providing this information to advertisers. The described method and system improves the user experience for users as the advertisement presentation and interaction mimics that of the native messaging application.

### Swipe-Able Advertisements

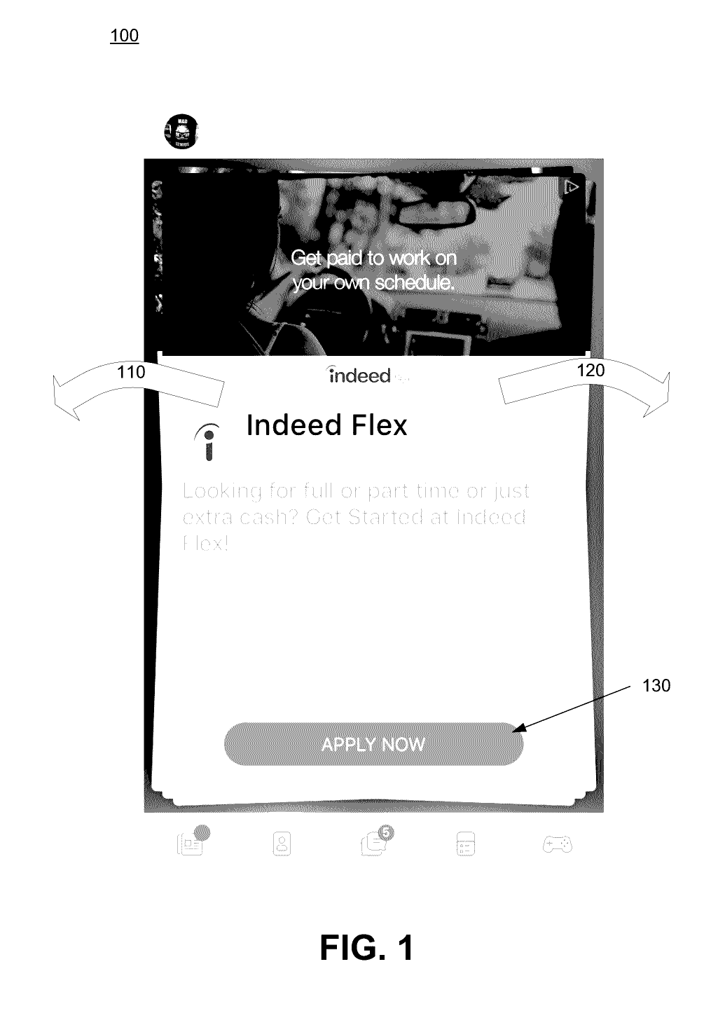

FIG. 1 illustrates an example advertisement 100 displayed within a messaging application, in accordance with an embodiment. As shown, advertisement 100 is an interactive advertisement, such that a user interacting with advertisement 100 can effect the information stored and/or presented. Left arrow 110 and right arrow 120 represent potential user interactions, also referred to as swiping interactions, with advertisement 100.

As described herein, a swiping interaction allows a user to drag their finger (or other implement such as a touch-screen enabled stylus) in a particular direction to effectuate an interaction. As shown, left arrow 110 represents a user dragging their finger from the right of advertisement 100 to the left. Similarly, right arrow 120 represents a user dragging their finger from the left of advertisement 100 to the right. In various embodiments described herein, a direction of the swiping interaction with advertisement 100 is indicative of a user's interest in advertisement 100.

In one embodiment, responsive to the direction of swiping interaction with advertisement 100 being to the left, as shown at left arrow 110, it is determined that the user is not interested in advertisement 100. In one embodiment, responsive to the direction of swiping interaction with advertisement 100 being to the right, as shown at right arrow 120, it is determined that the user is interested in advertisement 100.

In one embodiment, responsive to determining that the user is interested in advertisement 100, the messaging application is redirected to a landing page associated with advertisement 100. As described herein, a landing page refers to web page that opens in response to the user interaction indicating interest. In one embodiment, the landing page opens up directly within the messaging application. In another embodiment, the landing page opens up with a web browser application executed on the electronic device (e.g., mobile phone or smart phone) on which the messaging application is installed.

In one embodiment, the advertisement comprises call to action (CTA) button 130. In one embodiment, responsive to receiving a user interaction with CTA button 130, the messaging application is redirected to a landing page associated with advertisement 100. Analyzing activity received at the landing page allows advertisers and marketers to use click-through rates and conversion rate to determine the success of an advertisement. According to embodiments, when the user swipes advertisement 100 to the right, indicated by right arrow 120, or selects or otherwise interacts with CTA button 130, both actions can be monetized as cost per click (CPC) or can be optimized as monetized actions.

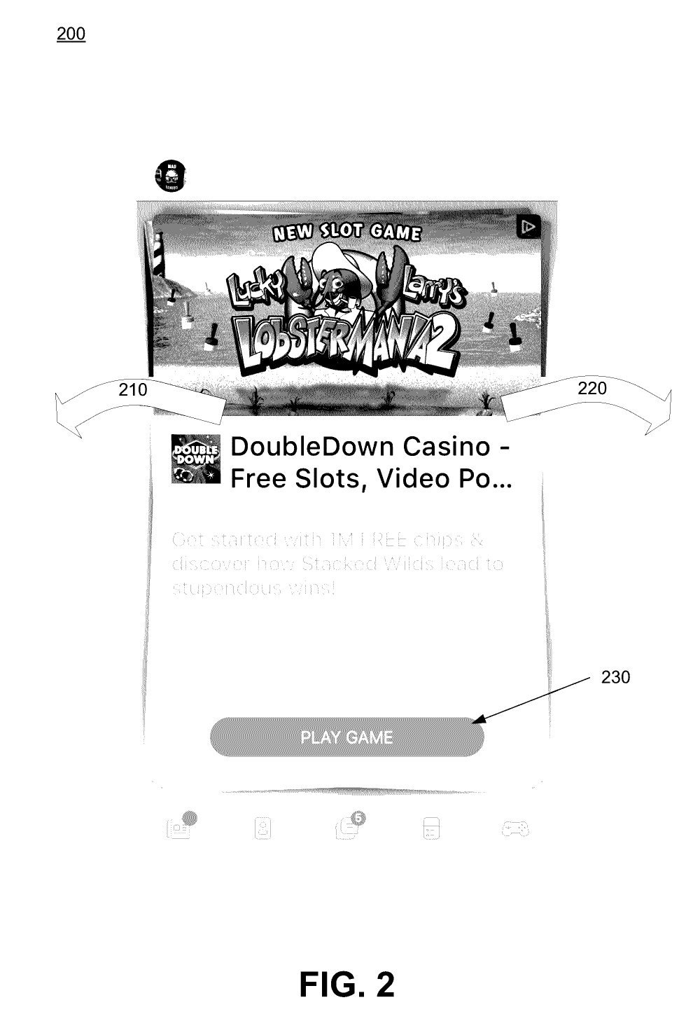

As shown in FIG. 1, advertisement 100 is an advertisement for credit. Accordingly, CTA button 130 directs a user to a landing page for applying for credit. However, it should be appreciated that many different types of advertisements may be used. FIG. 2 illustrates another example advertisement 200 displayed within a messaging application, in accordance with an embodiment.

As shown, advertisement 200 is an interactive advertisement, and operates in a similar manner as advertisement 100 of FIG. 1. Left arrow 210 and right arrow 220 represent potential swiping interactions with advertisement 200. In one embodiment, the advertisement 200 comprises CTA button 230. In one embodiment, responsive to receiving a user interaction with CTA button 230, the messaging application is redirected to a landing page associated with advertisement 200.

As shown in FIG. 2, advertisement 200 is an advertisement for video game. Accordingly, CTA button 230 directs a user to a landing page associated with accessing or playing the video game. For example, CTA button 230 may direct a user to a web page for downloading the video game or an application store for purchasing the video game (e.g., appstore, Google play, or webview). In another embodiment, where a user has already purchased or downloaded the video, interacting with CTA button 230 causes the video game to open. In one embodiment, the video game opens up directly within the messaging application. In another embodiment, the video game opens up on the electronic device (e.g., mobile phone or smart phone) on which the messaging application is installed.

Integrating Swipe-Able Advertisements into Profile Review

In various embodiments describe herein, swipe-able advertisements are integrated directly into profile review of a messaging application. For instance, a plurality of user profiles may be presented within the messaging application at the touch-screen display of the computing device, wherein each user profile is individually presented. A swiping interaction with each user profile is received at the touch-screen display of the computing device, wherein a direction of the swiping interaction with each user profile is indicative of a user's interest in each user profile. In one embodiment, the advertisement is presented as an interstitial between two user profiles of the plurality of user profiles.

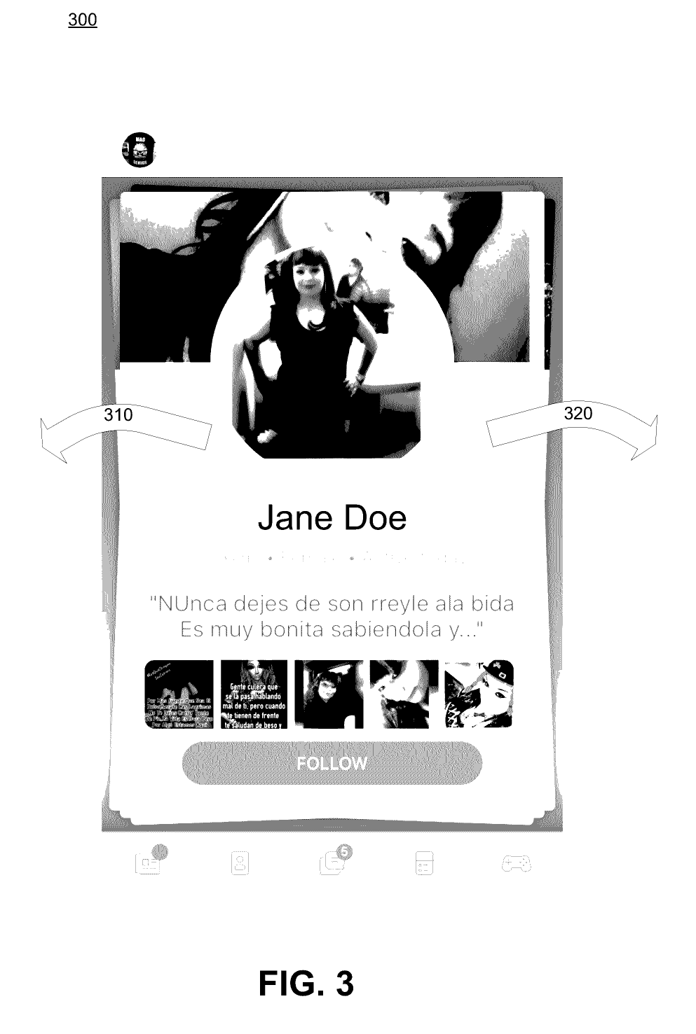

FIG. 3 illustrates an example user profile 300 of a messaging application, in accordance with an embodiment. As shown, left arrow 310 represents a user dragging their finger from the right of user profile 300 to the left. Similarly, right arrow 320 represents a user dragging their finger from the left of user profile 300 to the right. In various embodiments described herein, a direction of the swiping interaction with user profile 300 is indicative of a user's interest in user profile 300.

In one embodiment, responsive to the direction of swiping interaction with user profile 300 being to the left, as shown at left arrow 310, it is determined that the user is not interested in user profile 300. In one embodiment, responsive to the direction of swiping interaction with user profile 300 being to the right, as shown at right arrow 320, it is determined that the user is interested in user profile 300.

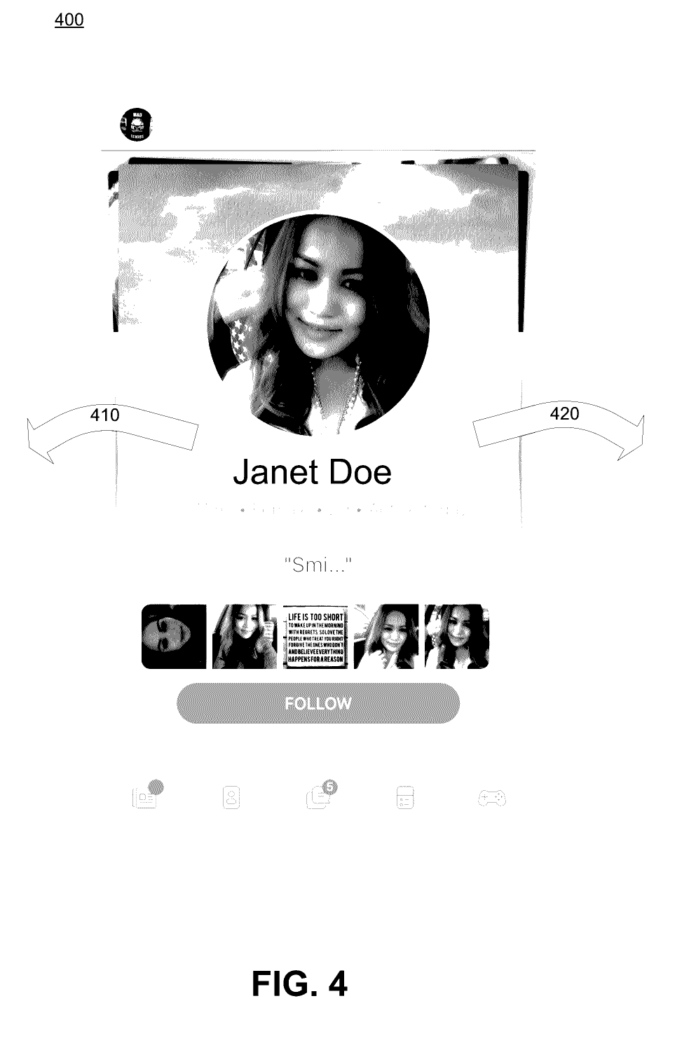

FIG. 4 illustrates another example user profile 400 of a messaging application, in accordance with an embodiment. As shown, left arrow 410 represents a user dragging their finger from the right of user profile 400 to the left. Similarly, right arrow 420 represents a user dragging their finger from the left of user profile 400 to the right. In various embodiments described herein, a direction of the swiping interaction with user profile 400 is indicative of a user's interest in user profile 400.

It should be appreciated that user profile 400 operates in a similar manner as user profile 300. In one embodiment, responsive to the direction of swiping interaction with user profile 400 being to the left, as shown at left arrow 410, it is determined that the user is not interested in user profile 400. In one embodiment, responsive to the direction of swiping interaction with user profile 400 being to the right, as shown at right arrow 420, it is determined that the user is interested in user profile 400.

In various embodiments, profile review of a messaging application allows users to quickly navigate through potential contacts by displaying full-screen (or partial-screen) user profile in succession. A user may rapidly indicate interest, or lack of interest, by using a swiping interaction with the user profiles. In one embodiment, if the user indicates interest in a user profile, by swiping to the right, a follow or contact request is sent to the user of the particular user profile, and the profile review proceeds to another user profile. If the user does not indicate interest in a user profile, by swiping to the left, the profile review notes the user is not interested in the user profile, and proceeds to another user profile. In this manner, a user can rapidly identify potential contacts by providing swiping interactions with the user profiles.

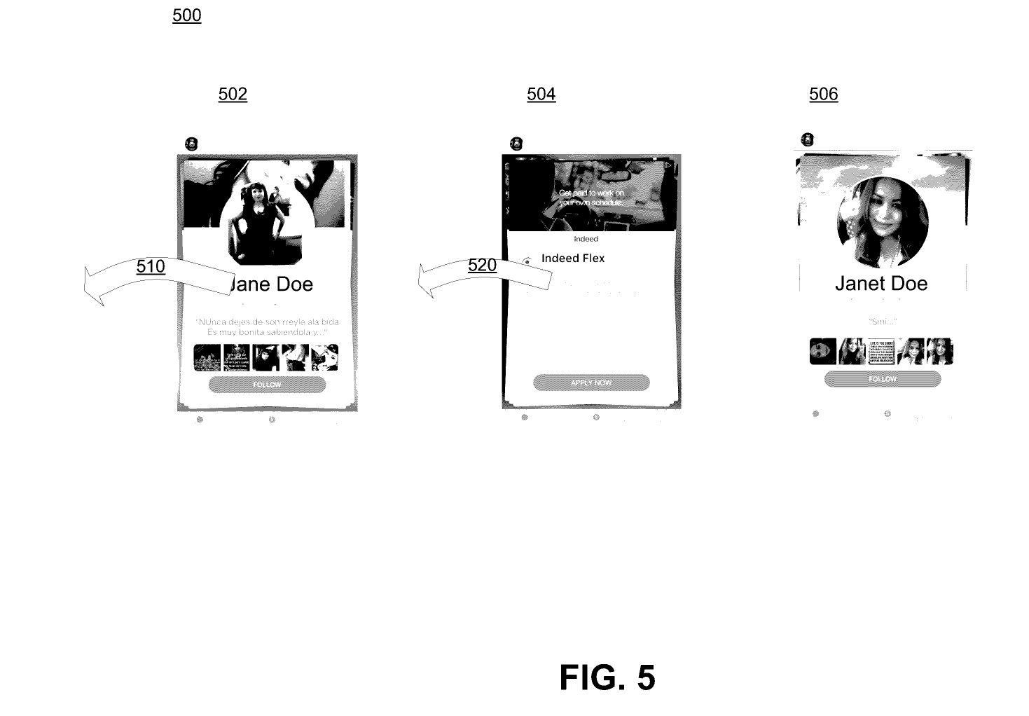

In accordance with various embodiments, advertisements can be presented as interstitials in profile review of a messaging application. FIG. 5 illustrates an example sequence 500 of an advertisement 504 displayed as an interstitial between user profiles, in accordance with an embodiment.

In one embodiment, as shown in sequence 500, a user is presented with user profile 502 with the profile review of a messaging application. The user interacts with user profile 502 with a swiping interaction to the left, as shown as left arrow 510. It should be appreciated that the swiping interaction with user profile 502 (whether to the right or to the left) may be indicative of user interest in user profile 502. In various embodiments, an action with respect to user profile 502 is taken (e.g., send a connection request to the user associated with user profile 502).

In one embodiment, after the swiping interaction, the user is presented with advertisement 504. This advertisement is presented as an interstitial during profile review of multiple user profiles of the messaging application. As shown, the user interacts with advertisement 504 with a swiping interaction to the left, as shown as left arrow 520. It should be appreciated that the swiping interaction with advertisement 504 (whether to the right or to the left) may be indicative of user interest in advertisement 504.

As shown in FIG. 5, upon swiping to the left, as shown with left arrow 520, to indicate that the user is not interested in the subject of advertisement 504, user profile 506 is presented. It should be appreciated a sequence of user profiles interlaced with advertisements may continue until a user selects to terminate profile review, or another intervening event occurs. For example, if a user swipes to the right of an advertisement, in one embodiment, the messaging application is redirected to a landing page associated with the advertisement. In another example, if a user interacts with a CTA button of the advertisement, the messaging application is redirected to a landing page associated with the advertisement. In another embodiment, if the user swipes to the right of a user profile, indicating an interest in a user associated with the user profile, the messaging application may initiate communication (e.g., a chat) between the user and the user associated with the selected user profile.

In accordance with various embodiments, advertisements may be presented in different formats or customizations. In one embodiment, the advertisement is a native advertisement. For example, the native advertisement may take up the entire page. The advertisement may include an image and a CTA button, where, if the user swipes to the right or interacts with the CTA button, the landing page associated with the advertisement will launch.

In other embodiments, the advertisement is a video advertisement. For example, the native video advertisement may take up the entire page. The native video advertisement may include an image thumbnail, a video player, and a CTA button, where, if the user swipes to the right or interacts with the CTA button, the landing page associated with the advertisement will launch. In one embodiment, clicking on the video will launch video in full screen. In another embodiment, the video begins playback automatically. In one embodiment, autoplay is the default for Wi-Fi users. In various embodiments, if the user swipes to the right or interacts with the CTA button, the landing page associated with the advertisement will launch.

In various embodiments, where the advertisement is presented within a portion of the messaging application, such as profile review, the messaging application can be configured to present an advertisement periodically after a number of swiping interactions are received. For example, in the user experience where user is swiping to explore more content (e.g., user profiles), swiping left or right for every profile shown indicates user's interest in the user profile. For every X swipes (where X could be number of swipes regardless of direction of the number of swipes to the right), an advertisement will show. It should be appreciated that X is configurable.

In other embodiments, the messaging application may be configured to present a particular number of advertisements to a user per session. For example, as soon as a user enters the swiping content experience, Y number of advertisements are called, where Y is configurable. In one embodiment, an advertisement is not refreshed while the advertisement is being displayed. An advertisement will be refreshed in the background if the advertisement expires.

Table 1 below describes additional features of the described embodiments.

TABLE 1

| # | User Story Title | User Story Description |
|---|---|---|
| AET1 | Native | The native advertisement will take up the entire page. The advertisement |
| | Advertisement | includes the following assets: |
| | | Image - 1200 × 627 |
| | | CTA button (optional) |
| | | If user swipes to the right or click on the CTA button, it will launch the landing |
| | | page (e.g., appstore, Google play, or webview). |
| AET2 | Native Video | The native video advertisement that shows up will take up the entire page. The |
| | Advertisement | advertisement consists of the following assets: |
| | | image thumbnail - 1200 × 627 (optional - if thumbnail is available, show this) |
| | | video player which renders VAST |
| | | CTA button (optional) |
| | | Clicking on the video will launch video in fullscreen |
| | | If user swipes to the right in the card view or click on the CTA button in both |
| | | card view and fullscreen, it will launch the landing page (appstore, Google |
| | | play, or webview). |
| | | auto-play/click-to-play control is configurable. By default, auto-play can be |
| | | set for Wi-Fi users only. |
| AET3 | Show an | In the experience where user is swiping to explore more content, swiping |
| | advertisement | left/right for every profile shown indicates user's interest. For every X swipe |
| | on every X | (where X could be # of swipes regardless of direction of # of swipes to the |
| | swipes | right), an advertisement will show. |
| | | X is configurable. |
| AET4 | Call Y # of | As soon as user enters the swiping content experience, call Y number of |
| | advertisements | advertisements, where Y is configurable. |
| | per session | The advertisements within Y numbers advertisement have to be de-duped |
| AET5 | Refresh | Do not refresh advertisement when the advertisement is showing in screen. |
| | advertisement | Background/Foreground will trigger advertisement refresh only if |
| | rules | advertisement expires (based on timeout config) |
| AET6 | Allow all | Although the configuration of inventory allocation (request and select config) |
| | advertisement | can go by default, all existing advertisement providers can serve on the |
| | providers to | advertisement unit. |
| | serve on this | |
| | advertisement | |
| | unit | |

Various embodiments described herein allow for the collection of various metrics based on the swiping interactions with an advertisement. Metrics associated with interactions with the CTA button of an advertisement may also be collected. For example, in various embodiments the following metrics may be collected:
The number of advertisements shown per session;
The number of clicks (e.g., interactions with CTA button);
The number of swipes to the left—indicates that user is not interested in the advertisement;
The number of swipes to the right—indicates that user is interested in the advertisement;
Country of user's location;
Advertisement provider which serves the advertisement; and
The user's platform (e.g., iOS, Android).

Thus, embodiments provide a method and system that enable advertisements to be displayed as part of a messaging application while providing the same user experience of the messaging application. Embodiments described herein enable business users to upload native advertisements that allow the users interactivity capabilities. Users can swipe the advertisement to the left or right to indicate the users' interest in the advertisements.

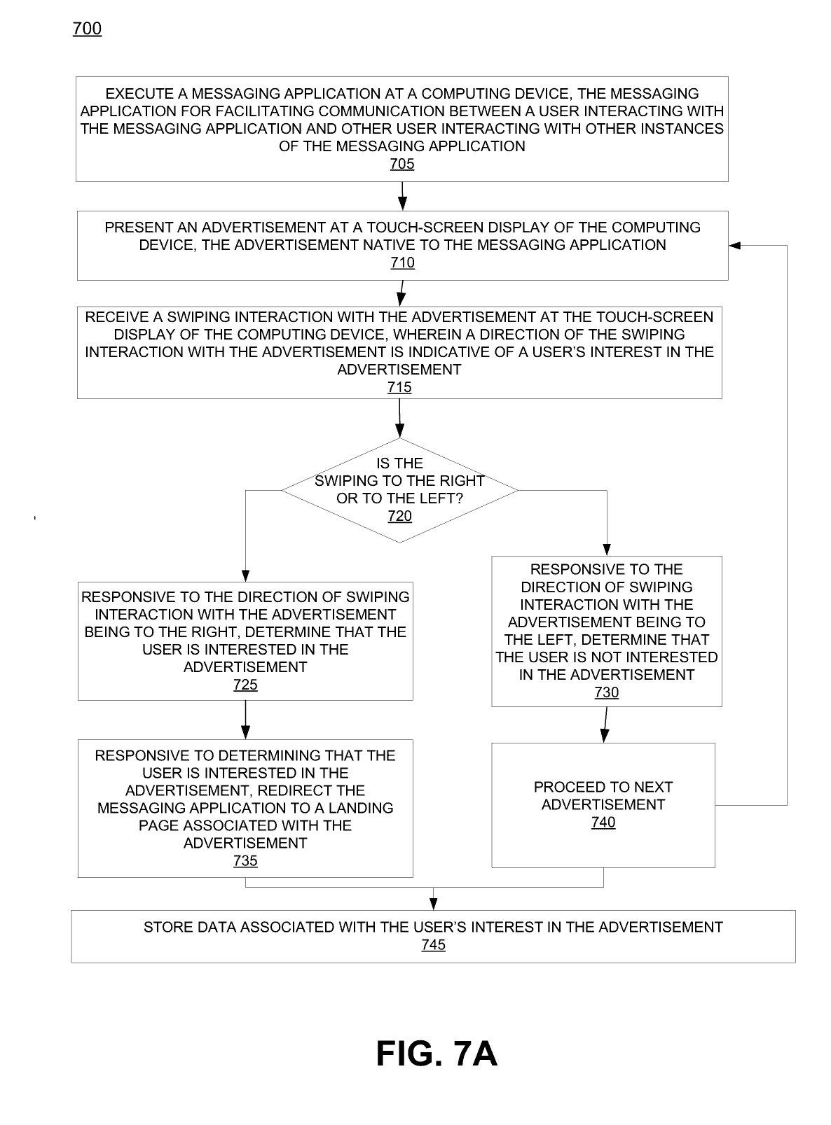

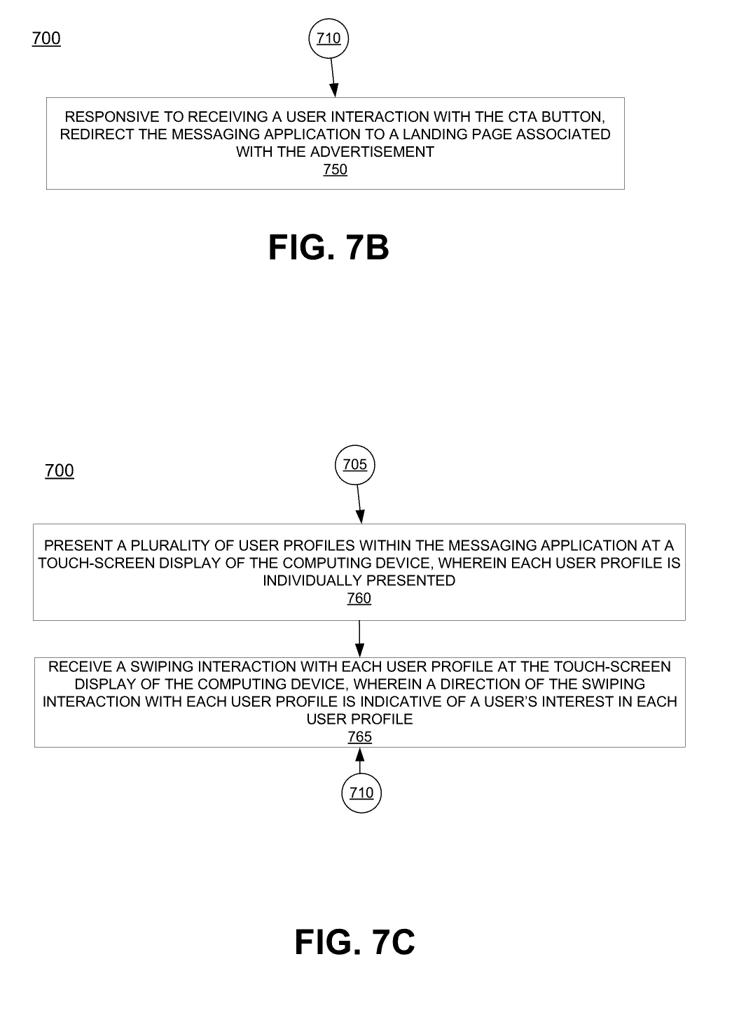

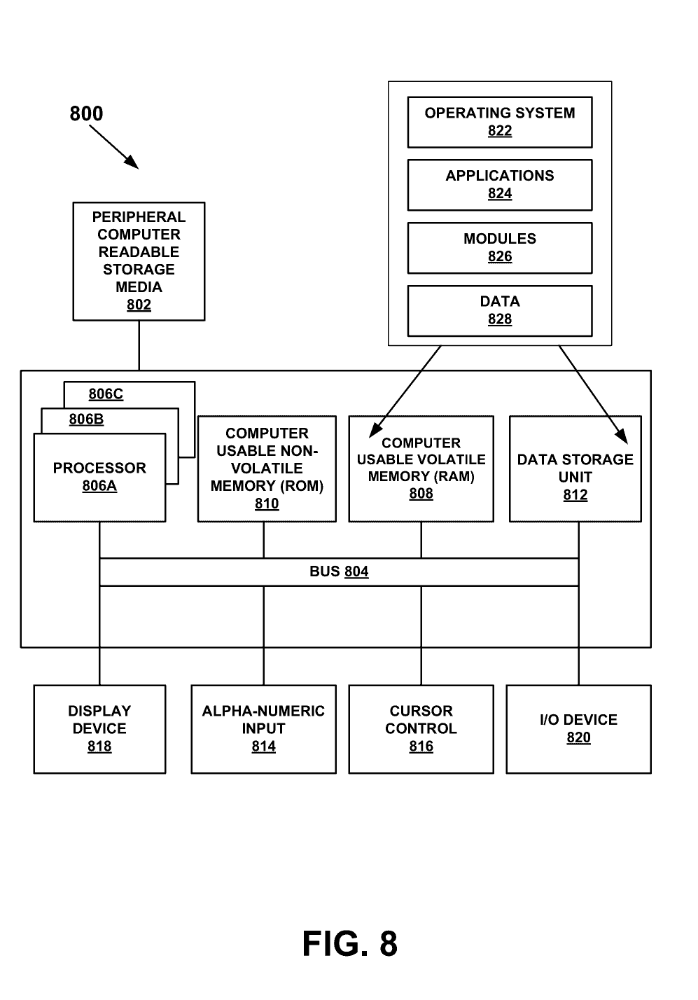

The following discussion will begin with a description of an advertisement presenter, with reference to FIG. 6. The discussion will follow with a description of a method for determining a user's interest in an advertisement, with reference to FIGS. 7A-7C. With reference to FIG. 8, the discussion concludes with a description of an example computer system with which or upon which various embodiments of the present technology may be implemented.

### Example Advertisement Presenter

FIG. 6 depicts a block diagram that illustrates an advertisement presenter 600 that includes the following modules coupled with a computer, such as computer 800 of FIG. 8: an selectable advertisement provider 605; a selection receiver 615; and a selectable advertisement integrater 625. The selectable advertisement provider 605 optionally includes a selectable advertisement presenter 610. In one embodiment, the advertisement presenter 600 resides at the messaging application service 630, while in another embodiment, the advertisement presenter 600 resides at a mobile phone 660 of a user 655. The messaging application service 630 is communicatively coupled with (via wire and/or wirelessly) the advertisement information server 640, the advertisement campaign manager 645 and the mobile phone 660. FIG. 6 also shows a chat advertisement system 635 that includes the advertisement information server 640, the messaging application service 630, and the advertisement campaign manager 645. FIG. 6 further shows that the business 650 is communicatively coupled with any of the following: the advertisement information server 640; the messaging application service 630; and the advertisement campaign manager 645. Of note, at least one of the modules of the chat advertisement system 635 is communicatively coupled with the mobile phone 660.

Also shown in FIG. 6 and located at the messaging application service 630 are the following components: a receiver 672; a processor 674; a display screen 680; a transmitter 676; and a memory device 678. In one embodiment, the memory device 678 is part of the advertisement presenter 600. In another embodiment, the memory device 678 is remote from, but communicatively coupled with, the advertisement presenter 600. In one embodiment, the advertisement presenter 600 resides at a messaging application service 630. In another embodiment, the advertisement presenter 600 is remote from, but coupled communicatively (via wire and/or wirelessly) the messaging application service 630. In one embodiment, the memory device 678 is located at a server remote from the messaging application service 630.

The advertisement presenter 600 will now be discussed, with reference to FIG. 6. The advertisement presenter 600 includes: the selectable advertisement provider 605; the selection receiver 615; the information presenter 620; and the selectable advertisement integrater 625.

The selectable advertisement provider 605 is configured for providing, at a display screen (of a mobile device), a selectable advertisement as part of a messaging application, wherein the selectable advertisement is implemented in a native code of the messaging application. For example, the selectable advertisement provider 605 provides, at the display screen 670 of the mobile device, such as mobile phone 660, and via the messaging application 665 downloaded onto the mobile phone 660 a selectable advertisement. The selectable advertisement is implemented in a native code of the messaging application 665. By selectable advertisement, for example, it is meant to include ads which are presented at the display screen 670, which may be selected by the user 655 via any method known in the art for selecting content from a mobile device (e.g., clicking, voice activated, pushing a button on the mobile device, etc.) In various embodiments, the selectable advertisement is configured to received swipe-able interactions, where the direction of the swiping interaction is indicative of the user's interest in the advertisement.

In one embodiment, the selectable advertisement provider 605 includes a selectable advertisement presenter 610. The selectable advertisement presenter 610 is coupled with a computer, such as the computer 800 of FIG. 8, and is configured for presenting the selectable advertisement at the display (e.g., such as the display screen 670) such that the selectable advertisement moves in unison with the content of the messaging application that is being displayed at the display screen 670. In other words, the selectable advertisement follows the same pattern of movement as the content that is being displayed on the display screen, in one embodiment. For example, the selectable advertisement may be configured to receive swiping interactions.

The selection receiver 615 is configured for receiving a selection of the selectable advertisement to achieve a selected advertisement. The selection initiates an execution of a set of instructions regarding a presentation of information associated with the selectable advertisement. For example, the user 655 selects one of the selectable advertisements displayed at the display screen 670. The selection receiver 615 then receives this selection. Once the message has been sent that a particular advertisement has been selected by the user 655, and this message is received at the advertisement presenter 600, an initiation of an execution of a set of instructions associated with said selection of the advertisement is performed. For example, if the user 655 clicks on a particular advertisement advertising a gaming application, the set of instructions may include sending more information about this gaming application, as well as the opportunity to download the gaming application, to the user 655. Another set of instructions may include sending to the user 655 information about co-branded gaming application, such that the user 655 may be made aware of other gaming applications generally played alongside this particular gaming application. Of note, the set of instructions may include any content that results in a presentation of information associated with the selected advertisement. In one embodiment, the set of instructions includes installing an application, wherein the presentation of information includes the application, and wherein the application is the subject of the selected advertisement. In another embodiment, the set of instructions includes displaying the application data regarding the application, wherein the presentation of information includes the application data, and wherein the application data includes a description of the application, wherein the application is the subject of the selected advertisement.

The information presenter 620 is configured for presenting the information according to the set of instructions. For example, the information presenter 620 may present a description of a gaming application, along with a download capability, to the user 655. In another embodiment, the information presenter 620 may present only the possibility to download the application that was advertised and was selected by the user 655. In one embodiment, for example, the selectable ad(s) are presented at the display screen 670 of the mobile phone 660, such that it moves in unison with the content of the messaging application 665 that is being displayed at the display screen 670 of the mobile phone 660. In one embodiment, the selectable content of the messaging application moves as part of a horizontal scroll. In another embodiment, the selectable content of the messaging application moves as part of a vertical scroll.

In one embodiment, the selectable advertisement integrater 625 integrates a set of selectable advertisements into a location of a messaging application in operation. In one embodiment, the location at which the selectable advertisements are integrated is a profile viewer of the messaging application. In another embodiment, the location at which the selectable advertisements are integrated is a social feed. In another embodiment, the location at which the selectable advertisements are integrated is a chat list. In yet another embodiment, the location at which the selectable advertisements are integrated is a profile page of the user.

In one embodiment, a chat advertisement system 635 includes the following components, communicatively coupled with a computer, such as the computer 800 of FIG. 8: the advertisement presenter 600 that includes the selectable advertisement provider 605, the selection receiver 615 and the information presenter 620; the advertising information server 640; and the advertisement campaign manager 645. The selectable advertisement provider 605 optionally includes a selectable advertisement presenter 610, in one embodiment. Additionally, the advertisement information server 640, the advertisement campaign manager 645 and the advertisement presenter 600 may each include its own receiver, processor, display screen, transmitter and memory device for performing a portion of the methods and systems described herein.

The advertisement information server 640 is communicatively coupled with the messaging application service 630 and a computer, such as the computer 800 of FIG. 8. The advertisement information server 640 is configured for creating an advertisement in native code of the messaging application. The advertisement campaign manager 645 is communicatively coupled with the messaging application service 630 and a computer, such as the computer 800 of FIG. 8. The advertisement campaign manager 645 is configured for managing an advertisement campaign for a set of clients (i.e., one or more clients). The advertisement campaign may be any set of instructions, requests, completed work and/or work to be completed and associated with advertisements for a client.

An input device, such as the I/O device 820 of FIG. 8, described herein below, is configured for receiving a selection of a selectable advertisement.

The processor 674 is configured for executing the methods described herein at least with regard to the advertisement presenter 600. The processor 674 may be implemented, for example, by one or more discrete modules (or data processing components) that are not limited to any particular hardware, firmware, or software (i.e., machine readable instructions) configuration. The processor 674 may be implemented in any computing or data processing environment, including in digital electronic circuitry, e.g., an application-specific integrated circuit, such as a digital signal processor (DSP) or in computer hardware, firmware, device driver, or software (e.g., machine readable instructions). In some implementations, the functionalities of the modules are combined into a single data processing component. In other versions, the respective functionalities of each of one or more of the modules are performed by a respective set of multiple data processing components.

The processor 674 is configured for, at least, performing the following processing steps: executing a messaging application at a computing device, the messaging application for facilitating communication between a user interacting with the messaging application and other user interacting with other instances of the messaging application, presenting an advertisement at a touch-screen display of the computing device, the advertisement native to the messaging application, receiving a swiping interaction with the advertisement at the touch-screen display of the computing device, wherein a direction of the swiping interaction with the advertisement is indicative of a user's interest in the advertisement, and storing data associated with the user's interest in the advertisement. In one embodiment, the processor 674 is further configured for integrating a set of selectable advertisements into a location of a messaging application in operation.

The memory device 678 stores process instructions (e.g., machine-readable code, such as computer software) for implementing methods executed by processor 674, as well as data that processor 674 generates or processes, as is discussed herein. The memory device 678 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices.

The receiver 672 is configured for, at least, receiving a selection of the selectable advertisement.

### Example Methods of Operation

The following discussion sets forth in detail some example methods of operation of embodiments. With reference to FIGS. 7A through 7C, a flow diagram of method 700 for determining a user's interest in an advertisement is shown, in accordance with embodiments. Method 700 includes some procedures that, in various embodiments, are carried out by a processor under the control of computer-readable and computer-executable instructions. In various embodiments, these computer-readable and computer-executable instructions are described as “code segments”, and presented separately (e.g., first codes segment, second code segment, etc.) to describe such instructions. In this fashion, procedures described herein and in conjunction with these flow diagrams, alone or in combination, are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware).

With reference to FIG. 7A, at procedure 705 of method 700, a messaging application is executed at a computing device, the messaging application for facilitating communication between a user interacting with the messaging application and other user interacting with other instances of the messaging application.

At procedure 710, an advertisement is presented at a touch-screen display of the computing device, the advertisement native to the messaging application.

At procedure 715, a swiping interaction with the advertisement is received at the touch-screen display of the computing device, wherein a direction of the swiping interaction with the advertisement is indicative of a user's interest in the advertisement.

At procedure 720, it is determined whether the swiping interaction was to the right or to the left. In one embodiment, as shown at procedure 730, responsive to the direction of swiping interaction with the advertisement being to the left, it is determined that the user is not interested in the advertisement. In one embodiment, method 700 then proceeds to procedure 740, where method 700 proceeds to the next advertisement, and returns to procedure 710. In one embodiment, method 700 also proceeds to procedure 745.

In another embodiment, as shown at procedure 725, responsive to the direction of swiping interaction with the advertisement being to the right, it is determined that the user is not interested in the advertisement. In one embodiment, as shown at procedure 735, responsive to determining that the user is interested in the advertisement, the messaging application is redirected to a landing page associated with the advertisement. In one embodiment, method 700 also proceeds to procedure 745.

At procedure 745, data associated with the user's interest in the advertisement is stored.

With reference to FIG. 7B, in one embodiment, the advertisement comprises a call to action (CTA) button. In the present embodiment, method 700 proceeds to procedure 750 after procedure 710. At procedure 750, responsive to receiving a user interaction with the CTA button, the messaging application is redirected to a landing page associated with the advertisement.

With reference to FIG. 7C, in one embodiment, method 700 proceeds to procedure 760 after procedure 705. At procedure 760, a plurality of user profiles are presented within the messaging application at the touch-screen display of the computing device, wherein each user profile is individually presented. At procedure 765, a swiping interaction with each user profile is received at the touch-screen display of the computing device, wherein a direction of the swiping interaction with each user profile is indicative of a user's interest in each user profile. In one embodiment, the advertisement is presented as an interstitial between two user profiles of the plurality of user profiles.

### Example Computer System

With reference now to FIG. 8, all or portions of some embodiments described herein are composed of computer-readable and computer-executable instructions that reside, for example, in computer-usable/computer-readable storage media of a computer system. That is, FIG. 8 illustrates one example of a type of computer (computer system 800) that can be used in accordance with or to implement various embodiments which are discussed herein. It is appreciated that computer system 800 of FIG. 8 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 800 of FIG. 8 is well adapted to having peripheral non-transitory computer-readable storage media 802 such as, for example, a floppy disk, a compact disc, digital versatile disc, other disc based storage, universal serial bus “thumb” drive, removable memory card, and the like coupled thereto.

System 800 of FIG. 8 includes an address/data bus 804 for communicating information, and a processor 806A coupled with bus 804 for processing information and instructions. As depicted in FIG. 8, system 800 is also well suited to a multi-processor environment in which a plurality of processors 806A, 806B, and 806C are present. Conversely, system 800 is also well suited to having a single processor such as, for example, processor 806A. Processors 806A, 806B, and 806C may be any of various types of microprocessors, and may be the processor 674 described with respect to FIGS. 6 and 7A-C. System 800 also includes data storage features such as a computer usable volatile memory 808, e.g., random access memory (RAM), coupled with bus 804 for storing information and instructions for processors 806A, 806B, and 806C.

System 800 also includes computer usable non-volatile memory 810, e.g., read only memory (ROM), coupled with bus 804 for storing static information and instructions for processors 806A, 806B, and 806C. In one embodiment, the memory device 880 of FIG. 6 is an example the computer usable volatile memory 808 and/or the computer usable non-volatile memory 810. Also present in system 800 is a data storage unit 812 (e.g., a magnetic or optical disk and disk drive) coupled with bus 804 for storing information and instructions. System 800 also includes an optional alphanumeric input device 814 including alphanumeric and function keys coupled with bus 804 for communicating information and command selections to processor 806A or processors 806A, 806B, and 806C. System 800 also includes an optional cursor control device 816 coupled with bus 804 for communicating user input information and command selections to processor 806A or processors 806A, 806B, and 806C. In one embodiment, system 800 also includes an optional display device 818 coupled with bus 804 for displaying information.

Referring still to FIG. 8, optional display device 818 of FIG. 8 may be a liquid crystal device, cathode ray tube, plasma display device or other display device suitable for creating graphic images and alphanumeric characters recognizable to a user. Optional cursor control device 816 allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. System 800 is also well suited to having a cursor directed by other means such as, for example, voice commands. System 800 also includes an I/O device 820 for coupling system 800 with external entities. For example, in one embodiment, I/O device 820 is a modem for enabling wired or wireless communications between system 800 and an external network such as, but not limited to, the Internet.

Referring still to FIG. 8, various other components are depicted for system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

The embodiments and techniques described above may be implemented in software as various interconnected functional blocks or distinct software modules. This is not necessary, however, and there may be cases where these functional blocks or modules are equivalently aggregated into a single logic device, program or operation with unclear boundaries. In any event, the functional blocks and software modules implementing the embodiments described above, or features of the interface can be implemented by themselves, or in combination with other operations in either hardware or software, either within the device entirely, or in conjunction with the device and other processor enabled devices in communication with the device, such as a server.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the disclosure is defined and limited only by the claims that follow

What is claimed is:

1. A computer-implemented method for determining a user's interest in an advertisement, the method comprising:
executing a messaging application at a computing device, the messaging application for facilitating communication between a user interacting with the messaging application and other user interacting with other instances of the messaging application;
presenting an advertisement at a touch-screen display of the computing device, the advertisement native to the messaging application;
receiving a swiping interaction with the advertisement at the touch-screen display of the computing device, wherein a direction of the swiping interaction with the advertisement is indicative of a user's interest in the advertisement; and
storing data associated with the user's interest in the advertisement.

2. The method of claim 1, further comprising:
responsive to the direction of swiping interaction with the advertisement being to the left, determining that the user is not interested in the advertisement.

3. The method of claim 1, further comprising:
responsive to the direction of swiping interaction with the advertisement being to the right, determining that the user is interested in the advertisement.

4. The method of claim 3, further comprising:
responsive to determining that the user is interested in the advertisement, redirecting the messaging application to a landing page associated with the advertisement.

5. The method of claim 1, wherein the advertisement comprises a call to action (CTA) button.

6. The method of claim 5, further comprising:
responsive to receiving a user interaction with the CTA button, redirecting the messaging application to a landing page associated with the advertisement.

7. The method of claim 1, further comprising:
presenting a plurality of user profiles within the messaging application at the touch-screen display of the computing device, wherein each user profile is individually presented; and
receiving a swiping interaction with each user profile at the touch-screen display of the computing device, wherein a direction of the swiping interaction with each user profile is indicative of a user's interest in each user profile.

8. The method of claim 7, wherein the advertisement is presented as an interstitial between two user profiles of the plurality of user profiles.

9. A computer-program product tangibly embodied in a non-transitory computer-readable storage medium, including instructions configured to cause one or more data processors to:
execute a messaging application at a computing device, the messaging application for facilitating communication between a user interacting with the messaging application and other user interacting with other instances of the messaging application;
present an advertisement at a touch-screen display of the computing device, the advertisement native to the messaging application;
receive a swiping interaction with the advertisement at the touch-screen display of the computing device, wherein a direction of the swiping interaction with the advertisement is indicative of a user's interest in the advertisement; and
store data associated with the user's interest in the advertisement.

10. The computer-program product of claim 9, the instructions further comprising:
responsive to the direction of swiping interaction with the advertisement being to the left, determine that the user is not interested in the advertisement.

11. The computer-program product of claim 9, the instructions further comprising:
responsive to the direction of swiping interaction with the advertisement being to the right, determine that the user is interested in the advertisement.

12. The computer-program product of claim 11, the instructions further comprising:
responsive to determining that the user is interested in the advertisement, redirect the messaging application to a landing page associated with the advertisement.

13. The computer-program product of claim 9, wherein the advertisement comprises a call to action (CTA) button.

14. The computer-program product of claim 13, the instructions further comprising:
responsive to receiving a user interaction with the CTA button, redirect the messaging application to a landing page associated with the advertisement.

15. The computer-program product of claim 9, the instructions further comprising:
present a plurality of user profiles within the messaging application at the touch-screen display of the computing device, wherein each user profile is individually presented; and
receive a swiping interaction with each user profile at the touch-screen display of the computing device, wherein a direction of the swiping interaction with each user profile is indicative of a user's interest in each user profile.

16. The computer-program product of claim 15, wherein the advertisement is presented as an interstitial between two user profiles of the plurality of user profiles.

17. A system, comprising:
one or more data processors; and
a non-transitory computer-readable storage medium containing instructions which when executed on the one or more data processors, cause the one or more processors to perform operations including:
executing a messaging application at a computing device, the messaging application for facilitating communication between a user interacting with the messaging application and other user interacting with other instances of the messaging application;
presenting a plurality of user profiles within the messaging application at a touch-screen display of the computing device, wherein each user profile is individually presented;
receiving a swiping interaction with each user profile at the touch-screen display of the computing device, wherein a direction of the swiping interaction with each user profile is indicative of a user's interest in each user profile;
presenting an advertisement at a touch-screen display of the computing device, the advertisement native to the messaging application, wherein the advertisement is presented as an interstitial between two user profiles of the plurality of user profiles;
receiving a swiping interaction with the advertisement at the touch-screen display of the computing device, wherein a direction of the swiping interaction with the advertisement is indicative of a user's interest in the advertisement; and
storing data associated with the user's interest in the advertisement.

18. The system of claim 17, the operations further comprising:
responsive to the direction of swiping interaction with the advertisement being to the left, determining that the user is not interested in the advertisement.

19. The system of claim 17, the operations further comprising:
responsive to the direction of swiping interaction with the advertisement being to the right, determining that the user is interested in the advertisement; and
responsive to determining that the user is interested in the advertisement, redirecting the messaging application to a landing page associated with the advertisement.

20. The system of claim 17, wherein the advertisement comprises a call to action (CTA) button, the operations further comprising:
responsive to receiving a user interaction with the CTA button, redirecting the messaging application to a landing page associated with the advertisement.
